(19) United States
(12) Patent Application Publication
(10) Pub. No.: US 2004/0045169 A1
(43) Pub. Date: Mar. 11, 2004

(54) Manufacture of combination spoon and straw utensils and novel straw and dip tube configurations

(76) Inventors: Eric M. Boettner, Cleveland, TN (US); John Erick Lawson, Cleveland, TN (US)

Correspondence Address: DOUGLAS T. JOHNSON, MILLER & MARTIN, 1000 VOLUNTEER BUILDING, 832 GEORGIA AVENUE, CHATTANOOGA, TN, 37402-2289, US

(21) Appl. No.: 10/650,651

(22) Filed: Aug. 28, 2003

Related U.S. Application Data
(60) Provisional application No. 60/409,649, filed on Sep. 10, 2002.

(51) Int. Cl. A47J 43/28

(52) U.S. Cl. 30/141; 30/324

(57) ABSTRACT

A combination spoon and straw utensil is advantageously manufactured on extrusion forming equipment, which also provides improved manufacture of straws or dip tubes with feature sections.

The present application claims priority of U.S. Provisional Application No. 60/409,649 filed Sep. 10, 2002, which is incorporated herein.

### FIELD OF THE INVENTION

The present invention relates generally to the manufacture of eating utensils with extrusion forming equipment, and more particularly, to a utensil combining spoon and straw functionality and novel straw and dip tube configurations.

### BACKGROUND OF THE INVENTION

Certain food items such as thick milkshakes, flavored ice drinks, and ice cream sodas may be advantageously consumed with a utensil that combines both a straw for consuming the liquid portion and a spoon for transporting solid portions of the food product. In addition, children often desire two different utensils for eating and drinking other food items with both fluid and solid components such as soup or cereal. Indeed food manufacturers utilize combination spoon and straw utensils as promotional items in cereal boxes to meet this consumer preference.

To satisfy product demands, and particularly to be sturdy for children's use, and to avoid small parts that present choking hazards, it is advantageous to have spoon straw devices molded from a single piece of plastic.

Prior spoon straw combinations have frequently been injection molded in multiple pieces such as shown in U.S. Pat. No. 5,946,807. While other spoon straw designers have stated that it was possible to manufacture products in a unitary mold, such unitary molds require different molds for each variation either in shape or in the length of the straw portion. Injection molding spoon straw utensils also leaves edges from sprues and ejector pins. In addition, straw configurations with substantial variations in shape cannot be economically produced with injection molding. Previous attempts to manufacture straws having a shape formed in the tube utilizing blow molding techniques have been too costly for the resulting products to be accepted.

The present invention overcomes the shortcomings found in the prior art and provides an improved spoon and straw combination utensil, and varied straw and dip tube configurations.

### SUMMARY OF THE INVENTION

The present invention preferably utilizes a mold or molds in a continuous vacuum extrusion process, such as on a vacuum corrugator. Alternatively, a pressure extrusion process may be utilized, again preferably on a continuous corrugator. The use of modular molds facilitates modifications to product design, either in length or in changes to the shape of portions of the utensils. In addition, the extrusion and vacuum process provides an excellent strength to plastic weight ratio and allows for a very high degree of detail in molding. Spoon and straw utensils manufactured according to the present invention may have a stiff spoon and a flexible or collapsible straw portion in the same product, may be constructed from a single piece of plastic so that there is no assembly required and no small parts to create a choking hazard, and do not require the removal of sprue edges as might be required with injection molded parts, and generally permit greater flexibility in product design. Straw and dip tube designs manufactured according to the process may include detailed shapes in the tubing wall that are not necessarily symmetrical.

For better understanding of the present invention, together with other further advantages, reference is made to the following description taken in conjunction with the accompanying drawings.

### BRIEF DESCRIPTION OF THE DRAWINGS

FIG. 1 is a perspective view from the top of a utensil in accordance with the present invention.

FIG. 2 is a perspective view from the bottom of a spoon and straw utensil in accordance with the present invention.

FIG. 3 is a top plan view of a spoon and straw utensil in accordance with the present invention.

FIG. 4 is a right plan view of a spoon and straw utensil in accordance with the present invention.

FIG. 5 is a front plan view of a spoon and straw utensil in accordance with the present invention.

FIG. 6 is a rear plan view of a combination spoon and straw utensil in accordance with the present invention.

FIG. 7 is an enlarged perspective view of the mold portion of the combination spoon and straw utensil according to the present invention.

FIG. 8 is a view of a combination spoon and straw utensil in accordance with the present invention as it might be used in a phantom cup to aspirate fluid through the straw portion.

FIG. 9 is a prospective view of a combination spoon and straw utensil in accordance with the present invention in use with phantom cup and phantom solid components carried in the spoon portion.

FIGS. 10A and 10B are a top plan view of spoon and straw utensil in accordance with the present invention, and a detailed view of the partial spoon portion respectively.

FIGS. 11A and 111B are a top plan view of spoon and straw utensil in accordance with the present invention, having an alternative new symmetric shape in the tube wall or dip tube, and a detailed view of the shape in the tube wall portion respectively.

FIGS. 12A and 12B are a top plan view of spoon and straw utensil in accordance with the present invention, and a detailed view of the open ended full spoon portion respectively.

FIGS. 13A and 13B are a top plan view of spoon and straw utensil in accordance with the present invention, and a detailed view of the closed ended full spoon portion respectively.

FIG. 14 is a top plan view of a straw or dip tube in accordance with the present invention, with shapes and corrugation.

FIG. 15 is a perspective view of a bottle with a section of wall removed to show a shaped dip tube on the interior.

### DETAILED DESCRIPTION OF THE INVENTION

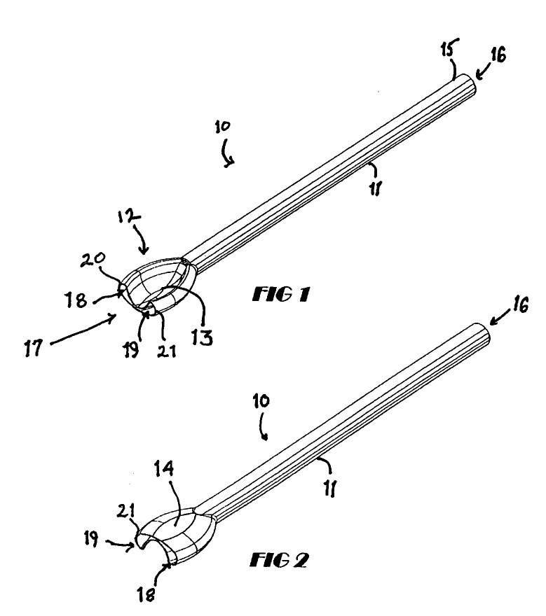

Turning to FIG. 1, a perspective view of a spoon and straw combination utensil 10 according to the present invention is illustrated with a handle portion 11 extending to proximal end 15 at where there is an opening 16 to an interior lumen. At the distal end of spoon straw utensil 10 is spoon bowl 12 formed from front wall 13. The edges of front wall 13 form curved section 20 to the left and curved section 21 to the right which join to back wall 14. Between front wall 13 and back wall 14 is formed the distal opening 17 to the interior lumen. If front wall 13 and back wall 14 contact in the deep section of the spoon bowl 12, then the distal lumen may be divided into left side lumen 18 and right side lumen 19. Such contact between front wall 15 and back wall 14 may be controlled by the rate of extrusion of resin as the spoon portion is molded. FIG. 2 is a bottom perspective view of the same spoon straw utensil 10 where back wall 14 of the spoon section 12 is more clearly visible.

A spoon straw utensil or straw configuration according to this invention is preferably formed by extruding a tube of thermoplastic resin from a head and conforming that tube to the interior of a mold tunnel formed by mold blocks. The mold blocks typically come in pairs and mate together to form a portion of the mold tunnel, and the thermoplastic is either blown into the shape of the mold tunnel (by pressure created within the mold tunnel) or by vacuum (where vacuum draws the air from around the mold tunnel). Such machines are often used to form corrugated pipe. A typical corrugation machine suitable for the manufacture of spoon straw utensils 10 according to the present invention is Cullom Machine Tool & Die, Inc.'s TVC System, a vacuum corrugator that can process up to 200 feet of clamshell mold block tunnel sections per minute. Slightly less preferred due to slower speed and the creation of flash that has to be trimmed from the formed products are blow molding processes. Both corrugation and blow molding processes are described as extrusion forming processes, although only corrugation is referenced as a continuous extrusion molding process. Blow molding is more expensive than corrugation, and for the more price sensitive straws and dip tubes, having shapes in the tube walls, only corrugation results in economical products.

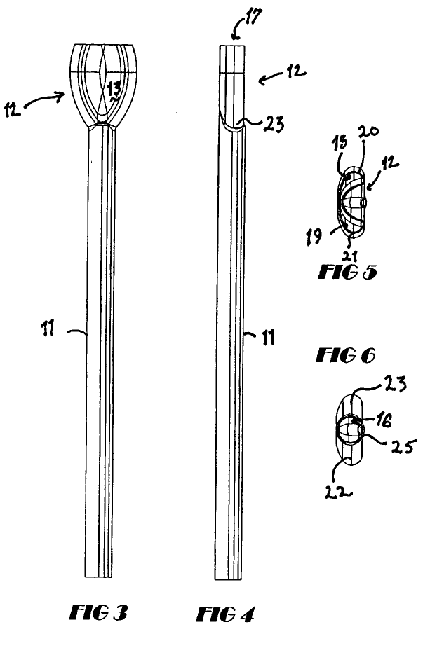

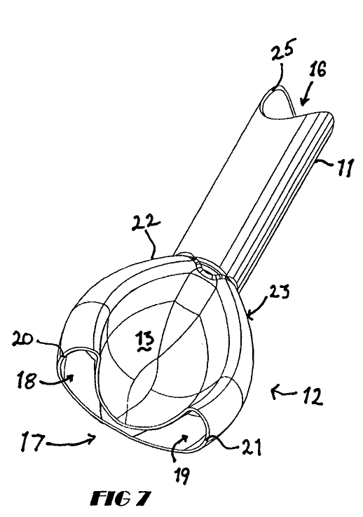

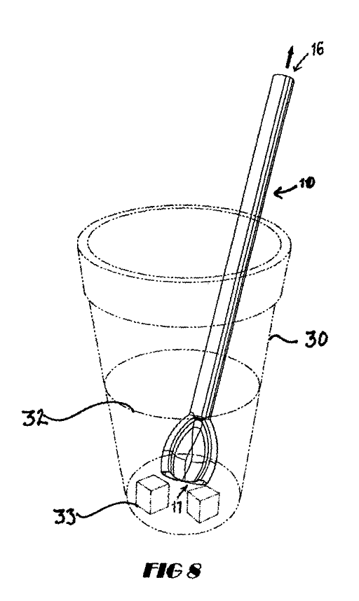

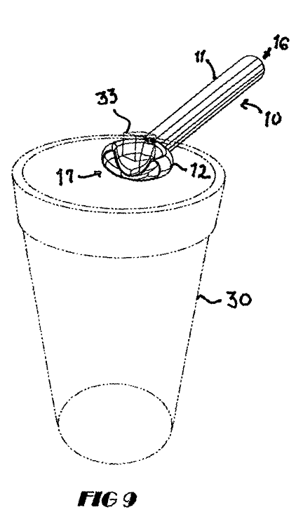

FIGS. 3 through 7 are additional views of the spoon straw utensil 10 illustrated in FIGS. 1 and 2, showing details such as left shoulder 22 and right shoulder 23 at the proximal portion of bowl 12 and showing handle tube wall 25 in FIGS. 6 and 7.

In FIG. 8 the spoon straw utensil 10 is shown in operation in a container 30 filled with fluid 32 and a solid or semi-solid components 33. By applying suction at proximal end opening 16, fluid 32 is drawn into distal end opening 17 and through the spoon straw utensil. FIG. 9 illustrates the spoon straw utensil 10 utilized to lift one of the semi-solid or solid components 33 in the bowl 12.

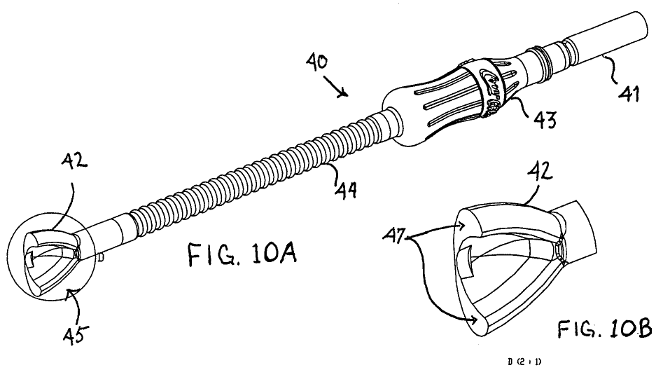

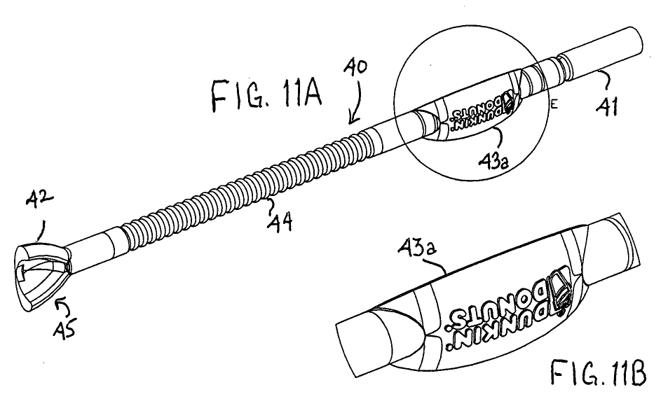

Due to the use of mold blocks to form the spoon straw utensils, a wide variety of spoon straw utensil configurations are possible. For instance, with a second general configuration of spoon straw utensil 40 shown in FIGS. 10 through 13, some of the same mold blocks that were utilized to form first spoon straw utensil 10 in FIG. 1 might be utilized to form the smooth straw portion 41 and the transition between bowl 42 and the handle portion. However, spoon straw utensil 40 also has a corrugated straw section 44 and a bottle-shaped section 43 formed in the handle, that require different mold blocks to form.

When the diameter of the straw portion changes, as by the inclusion of a shape such as a bottle 43, animal or other ornamental feature 43a, it is usually desirable to change the extrusion rate of the resin in order to maintain sufficient wall thickness. It is not typically necessary to change the extrusion rate to form the spoon portion. However, if the extrusion rate is increased, the spoon walls will be thicker. Adjusting the extrusion rate can also impart flexibility to particular portions of the straw.

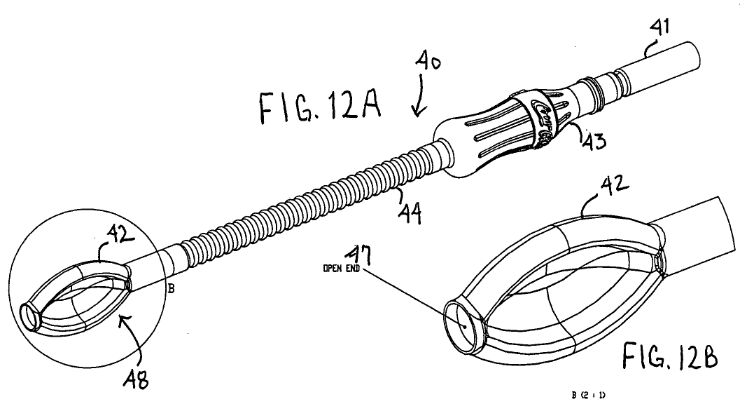

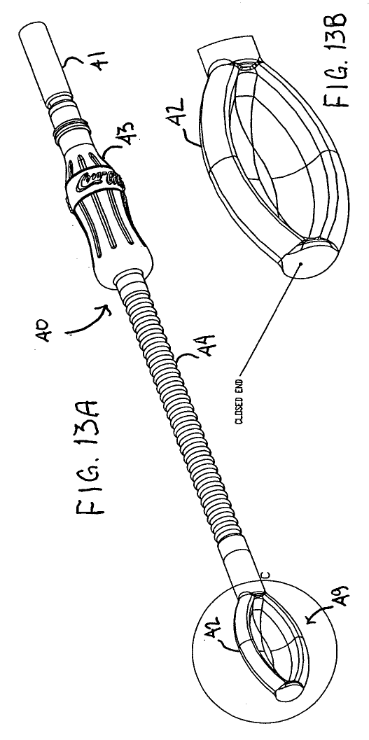

In addition, the molded spoon straws can be cut to vary the shape and length of the spoon portion. For instance, in FIGS. 10 and 11, the bowl portion 42 is only a half spoon 45 and the lumen 47 connects through the interior of half spoon 45 into the straw portion 41. In FIGS. 12 and 13 a full spoon 48,49 is formed. In the full spoon 49 configuration of FIG. 13, the end of the spoon is sealed so that the molded utensil is simply a hollow spoon. FIG. 12 shows an alternative configuration where bowl 42 is also a full spoon 48, but instead of having a sealed distal end, lumen 47 remains open to provide communication into the straw portion 41. These numerous variations of the bowl of the spoon are possible by altering the cut line between units.

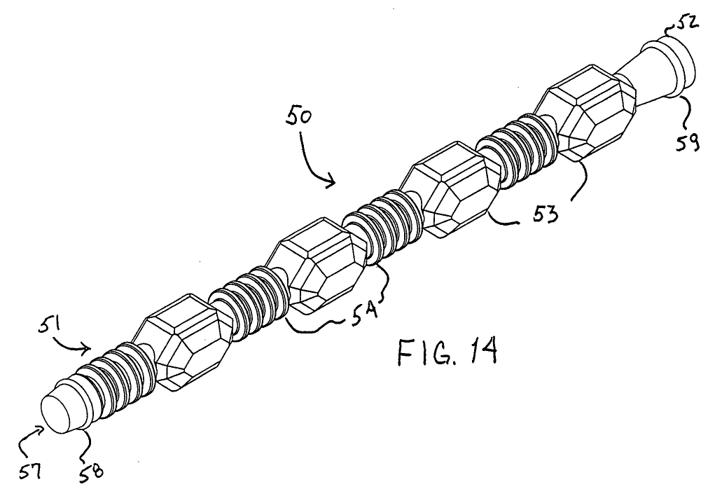

It will be seen that by the simple expedient of changing mold blocks on the molding machine, the shape of bottle portion 43 of the straw may be converted to other desired shapes such as a wedge-shaped logo device 43a shown in FIG. 11. Also, the corrugated portion 44 or smooth portion 41 may also be easily modified to other configurations. For example, in FIG. 14, another straw 50 is shown in which there is no spoon portion. The handle portion 51 of spoon straw utensil 50 is modified from the spoon straws of FIGS. 10-13 by the inclusion of multiple corrugated sections 54 and multiple jewel-shaped sections 53 to provide novel ornamentation to this handle portion 51. Once more, straw utensil 50 has an interior lumen 57 permitting communication between the distal end 52 and the handle 51. Varied extrusion rates can provide uniform wall thickness along the length of the straw portions, even with features of greater diameter such as jewel sections 53.

In the variations resulting in only a straw such as FIG. 14, the spoon portion is omitted and there may be one or multiple feature sections and when appropriate, one or multiple corrugated sections. A multiple feature and corrugated sectioned straw may be fitted with a slightly tapered proximal end 58 and slightly flared distal end and projecting circumferential rib portions 59 as described in the toys of U.S. Pat. No. 5,395,278. By forming the corrugated sections with relatively thin walls as by adjusting the extrusion rate of the resin, the resulting straw can be easily bent and snapped into shape as a bracelet or necklace. It will be understood that straws may be formed with features, such as bottle shapes, animal shapes or the like, and the remainder of the straw may have corrugated sections or simply be straight and uniform tubing. When the feature sections vary the diameter of the straw the extrusion rate of the plastic is usually changed to maintain uniform wall thickness. It is even possible that the feature sections will not be completely symmetrical, although generally symmetrical shapes are needed for the best molding results.

By utilizing modular tooling on a vacuum or blow extrusion corrugating machine, the length of spoon straw utensils may be easily varied by simply adding additional mold blocks for the handle portion. In addition, features such as shapes or corrugation may be easily added to or removed from the handle. As shown in FIG. 12 and FIG. 13, a product may be easily configured as either a standard spoon product or a spoon straw utensil. FIGS. 10 through 13 show the ease of varying the product from a hollow spoon such as FIG. 13 to a straw with a full spoon bowl such as in FIG. 12 to a straw with a partial bowl such as in FIGS. 10 and 11. The use of a continuous vacuum or blow extrusion molding machine even allows different products to be run at the same time on one molding machine. Blow molding processes may also be used to produce these products but may require additional molds to effect product variations, and typically have slower production rates.

A further advantage to the continuous blow or vacuum tubular extrusion processes utilized in the manufacture of spoon straw or straw utensils according to the present invention is that the extrusion process orients the resin molecules for improved stiffness in the machine direction while the process of expanding the tube to fill the molds orients the resin molecules for stiffness in the direction transverse to the machine. This allows for the manufacture of rigid spoon straw utensil and decorative straw products with minimum wall thickness and resin weight.

The continuous tubular extrusion with vacuum or blow expansion to fill the modular molds provides a very high degree of detail and allows shapes not possible with injection molding or rotational molding. The modular clamshell mold machines also provide speed advantages over injection molding, blow molding or rotational molding and the continuous clamshell molds allow for better cooling of the molded products.

Spoon straw utensils manufactured according to the present invention may have a stiff spoon and a flexible or collapsible handle part in the same product, may provide for one piece construction of the utensil, may provide for advantageous distal lumen placement to improve straw functionality, and may provide relatively stiffer bowl portions, resulting especially from the reinforcement provided by the left and right curved sections and left and right shoulders of the bowl. In addition, dimensions of the bowl are not limited by the diameter of the lumen or straw portion, but are effectively limited only by the capacity of the molding machine. Extrusion molding on a corrugator also avoids the flash along the length of the utensils that would have to be trimmed off and recycled if blow molding were utilized. The extrusion process on a corrugator or in blow molding processes also allows for multiple layers to be coextruded so that colors and expensive additives can be used only in the outside layer (or interior layer if desired) which is not possible in injection molding. In addition, no sharp edges are left on finished parts from extrusion molding as might be the case with injection molded parts that require the use of sprues and ejector pins. Finally, the use of extrusion molding permits the manufacture of long parts with thinner lumen walls than would otherwise be possible.

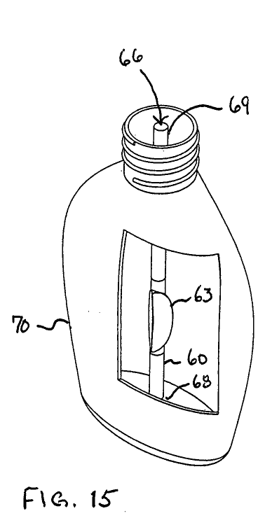

The inexpensive manufacture of straws with one or more shaped feature portions or corrugated portions using the continuous extrusion processes makes the resulting straws suitable for use as dip tubes. FIG. 15 depicts a representative dip tube 60 with a shaped feature portion 63, a proximal end 68 and a distal end 69 and interior lumen 66. The dip tube 60 is positioned in a representative bottle 70, preferably made of transparent glass or plastic, and filled with a transparent soap, shampoo, lotion or the like, and dispensed by a pump (not shown). The proximal end 68 of the tube is connected to the pump and the distal end 69 extends to near the bottom of bottle 70. Generally, the transparent nature of the contents of bottle 70 will warrant a central placement of a feature portion 63 along the dip tube. However, if used with opaque contents, the feature portion could be positioned near the proximal end, to be visible after only a small portion of the contents have been dispensed.

While what are presently believed to be preferred embodiments of the invention are described above, those skilled in the art will realize that various changes and modifications may be made to the invention without departing from the spirit of the invention, and it is intended to claim all such changes and modifications as fall within the spirit and scope of the specification and appended claims.

What is claimed is:

1. A spoon and straw combination utensil formed of resin on extrusion forming equipment and having a tubular handle portion and a bowl portion, wherein the bowl portion is formed of a front wall and a back wall, said front and back walls being connected by a left curved wall and a right curved wall and defining a lumen between such front and back walls.

2. A spoon and straw combination utensil of claim 1 wherein the utensil is formed on continuous corrugating equipment having pairs of molds.

3. A spoon and straw combination utensil of claim 1 wherein a shape feature is included in the tubular portion.

4. A spoon and straw combination utensil of claim 1 wherein the shape feature is asymmetrical.

5. A spoon and straw combination utensil of claim 1 wherein a corrugated section is included in the tubular portion.

6. A spoon and straw combination utensil of claim 1 wherein the bowl portion is cut laterally to leave only about a half spoon.

7. A spoon and straw combination utensil of claim 1 wherein the front wall and the back wall contact in the center of the bowl portion.

8. A spoon and straw combination utensil of claim 1 wherein the bowl portion forms a full spoon.

9. A spoon and straw combination utensil of claim 8 wherein the bowl portion is sealed at the distal end and the utensil does not function as a straw.

10. A spoon and straw combination utensil of claim 2 wherein the extrusion process orients the resin molecules for stiffness in the machine direction while expanding the resin extrusion to fill the molds orients the resin molecules for stiffness in the direction transverse to the machine.

11. A straw formed on continuous extrusion corrugating equipment having mold pins and comprising a tubular portion extending from a proximal end to a distal end and defining a lumen between said ends, and a feature portion in an asymmetrical shape of varied diameter from the tubular portion intermediate said tubular portion.

12. The straw of claim 11 wherein a corrugated section is included in the tubular portion.

13. The straw of claim 11 wherein the extrusion process orients the resin molecules for stiffness in the machine direction while expanding the resin extrusion to fill the molds orients the resin molecules for stiffness in the direction transverse to the machine.

14. The straw of claim 11 wherein the shape of the feature portion is selected from the group consisting of a bottle, a wedge, and an animal.

15. The straw of claim 11 wherein the proximal end is slightly tapered with a projecting circumferential ridge portion and the distal end is slightly flared with a circumferential rib portion.

16. The straw of claim 11 serving as a dip tube wherein the proximal end of the straw is in communication with a pump top of a bottle of fluid and the distal end is proximate a bottom portion of said bottle.
